(19) United States
(12) Patent Application Publication
(10) Pub. No.: US 2009/0020910 A1
(43) Pub. Date: Jan. 22, 2009

(54) SYSTEM AND METHOD FOR DEPOSITING THIN LAYERS ON NON-PLANAR SUBSTRATES BY STAMPING

(76) Inventors: Stephen Forrest, Ann Arbor, MI (US); Xin Xu, Ann Arbor, MI (US); Marcelo Davanco, Silver Spring, MD (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 12/186,197

(22) Filed: Aug. 5, 2008

Related U.S. Application Data
(63) Continuation-in-part of application No. 11/711,115, filed on Feb. 27, 2007.

(51) Int. Cl. B29C 45/16

(52) U.S. Cl. 264/259

(57) ABSTRACT

An optoelectronic device may be fabricated on a three dimensional surface by transferring a material from an elastomeric stamp to a non-planar substrate. The use of an elastomeric stamp allows for patterned layers to be deposited on a non-planar substrate with reduced chance of damage to the patterned layer. The material may be deposited on the stamp while the stamp is in a planar configuration or after the stamp has been deformed to a shape generally the same as the shape of the non-planar substrate. The material may be transferred by cold welding. The device may include organic layers.

This application is a continuation-in-part of U.S. application Ser. No. 11/711,115, filed Feb. 27, 2007, entitled System and Method for Depositing Thin Layers on Non-Planar Substrates by Stamping, and which is incorporated by reference in its entirety.

### FIELD OF THE INVENTION

The present invention relates to depositing material on non-planar substrates using a stamp. More specifically, it relates to depositing metal layers on non-planar substrates using an elastomeric stamp.

### BACKGROUND

Metals, organics, and other solid materials may be deposited on a flexible substrate, which is then deformed into a desired configuration after the material has been deposited. For example, a metal electrode may be deposited on a flexible substrate for use in an organic light emitting device. However, such a substrate does not allow for arbitrarily-shaped devices to be formed since the flexible substrate and/or any layers deposited on the substrate may be damaged or destroyed if the substrate is deformed beyond a certain point. For example, a flexible indium tin oxide (ITO) substrate can be rolled, but can not be formed into a dome or other ellipsoidal shape without damaging the substrate or layers on the substrate. Deposition of material onto a non-planar substrate would be useful for a variety of applications, including organic light emitting, photosensitive devices, and other optical applications. However, deposition of material, and specifically patterned layers of material, directly onto a non-planar substrate has not previously been realized.

### SUMMARY OF THE INVENTION

An optoelectronic device may be fabricated on a three dimensional surface by transferring a material from an elastomeric stamp to a non-planar substrate. The material may be deposited on the stamp while the stamp is in a planar configuration or after the stamp has been deformed to a shape generally the same as the shape of the non-planar substrate. The material may be a metal. The material may also be transferred by cold welding. The device may include organic layers. The device may also be an organic photodetector focal plane array.

### BRIEF DESCRIPTION OF THE DRAWINGS

FIG. 1A shows an elastomeric stamp on a vacuum mold.

FIG. 1B shows a deformed elastomeric stamp on a vacuum old.

FIG. 1C shows an elastomeric stamp disposed between a substrate and a curved surface.

FIG. 2 shows a vacuum mold and an elastomeric stamp used to deposit a layer of material on a substrate.

FIG. 3 shows a vacuum mold and an elastomeric stamp used to deposit a layer of material on a substrate.

FIG. 4 shows a vacuum mold and an elastomeric stamp used to deposit a layer of material on a substrate.

FIG. 5 shows a vacuum mold and an elastomeric stamp used to deposit a layer of material on a substrate.

FIG. 6 shows a circular non-planar substrate.

FIG. 7A shows a side cross section of an ellipsoidal substrate.

FIG. 7B shows a bottom view of the ellipsoidal substrate shown in FIG. 7A.

FIG. 8A shows a patterned elastomeric stamp.

FIG. 8B shows a patterned elastomeric stamp coated with a material to be deposited.

FIG. 8C shows a coated, patterned elastomeric stamp in contact with a substrate.

FIG. 8D shows a coated, patterned elastomeric stamp in contact with a substrate.

FIG. 9A shows an organic, passive matrix FPA on a hemispherical substrate.

FIG. 9B shows an FPA with micrometer scale dimensions on a hemispherical surface.

FIG. 10A shows an image of an Au stripe array transferred onto a PETg hemisphere.

FIG. 10B shows an image of an array of 40 μm wide stripe patterned on a hemispherical substrate.

FIG. 11A shows the current density vs. voltage characteristics of a photodetector fabricated on a hemispherical substrate.

FIG. 11B shows the current density vs. voltage characteristics of a photodetector fabricated on a hemispherical substrate and a comparable device.

FIG. 11C shows the external quantum efficiency as a function of the wavelength for a photodetector fabricated on a hemispherical substrate.

FIG. 11D shows a transmission spectrum of a PETg substrate with and without a patterned Au anode array.

FIG. 12 shows the photocurrent density vs. input power density for a photodetector fabricated on a hemispherical substrate.

### DETAILED DESCRIPTION

A vacuum mold has a rigid casing with an opening and an interior cavity connected to a vacuum source. An elastomeric stamp may be placed over the opening and deformed by applying a vacuum to the interior cavity. It has been found that elastomeric stamps may be suited for use in depositing material, and specifically for depositing patterned layers, on a non-planar substrate. Past efforts at depositing layers on non-planar substrates have been rendered difficult or ineffective because the material deposited on a hard, non-elastomeric stamp is prone to cracking or breaking when the stamp is deformed to the shape of the substrate. It is believed that use of an elastomeric stamp as described herein may reduce such problems. The elastomeric stamp may allow for use of a stamp that can be readily coated with material to be deposited after the stamp has been deformed, reducing strain on the coating, or before the stamp has been deformed, for ease of deposition on a planar substrate. It may further allow material on the stamp to “slide” slightly along the stamp surface, preventing strain and damage due to “bunching” of the material when the stamp is deformed. For example, when a non-elastomeric stamp is coated with a metal to be deposited on a substrate and the stamp is deformed such that the metal is on a concave surface of the stamp, the metal coating may move relative to the stamp such that the metal coating covers a relatively smaller fraction of the stamp than when the stamp is in a planar configuration. Thus the metal coating is not stretched by the change in surface area or shape of the stamp, and is less likely to be damaged due to the deformation.

The methods and systems described herein may be particularly useful in the fabrication of small-scale and/or sensitive devices or devices requiring deposition of sensitive materials or layers. For example, they may be preferred for fabricating optoelectronic devices such as photodetectors and organic light emitting diodes (OLEDs). Such devices often use materials that are sensitive to deformation, heat, pressure, and the like. They may also make use of thin layers of metals, such as for electrodes, where it can be desirable for the metal layers to be relatively smooth at the micron or nanometer scale to prevent damage to later-deposited organic layers or other sensitive layers. The sensitivity of these materials may further emphasize the difficulties of depositing thin layers on a non-planar substrate discussed above, since they can be particularly sensitive to substrate damage cause by deformation, stretching, and the like. As described in further detail below, the use of methods and systems described herein may reduce problems inherent in typical methods of deposition when applied to non-planar substrates, allowing for fabrication of optoelectronic devices such as photodetectors and OLEDs. The methods and systems described herein may also be particularly suited to small-scale deposition. For example, they may be useful in depositing layers with a pattern having a smallest dimension of 5 nm to 3 μm.

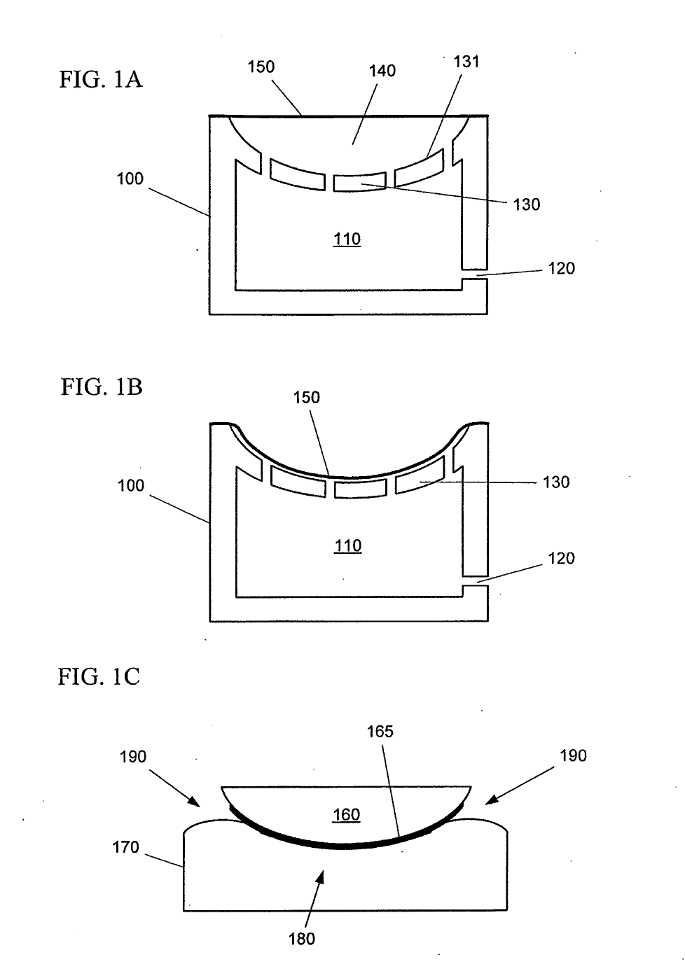

An exemplary vacuum mold 100 and elastomeric stamp 150 are shown in FIG. 1A. It will be understood that the drawings referred to herein are not drawn to scale, and some features may be exaggerated or omitted for clarity. Although a rectangular mold is shown for illustration purposes, the vacuum mold may be any shape. For example, a cylindrical vacuum mold may have an interior connected to a vacuum source. An elastomeric stamp may be placed over an opening on the side of the cylindrical mold, i.e., the surface that is not a circular end surface. When a vacuum is applied by the vacuum source, the elastomeric stamp may deform into the interior of the cylindrical vacuum mold. Other shapes and configurations of vacuum molds may be used.

A vacuum mold and elastomeric stamp as described herein may be particularly useful for depositing material on a non-planar substrate having three dimensionally deformed surfaces, such as a semi-spherical substrate or other non-planar configuration where a roll-to-roll or similar process cannot be used.

The vacuum mold 100 has an interior cavity 110 connected to a vacuum source, such as by a second opening 120 in the vacuum mold. An elastomeric stamp 150 may be placed over the main opening in the vacuum mold 140 and hermetically sealed to the circumference of the opening. When a vacuum is applied to the vacuum mold, the elastomeric stamp may be deformed into the vacuum mold.

The vacuum mold may have a permeable or semi-permeable surface 130. Such a surface may be desirable to prevent the elastomeric stamp 150 from deforming into the vacuum mold beyond a desired amount. It may also be used to deform the stamp into a specific desired shape, such as when the surface 130 has the same general shape as the substrate on which material is to be deposited. Preferably, it has a surface that is concave in the direction away from the vacuum chamber, such as outer surface 131 shown in FIG. 1A. FIG. 1B shows an elastomeric stamp 150 partially deformed by a vacuum applied to the interior cavity 110 of the vacuum mold 100. As discussed in further detail below, the stamp 150 may be deformed until it comes into contact with the surface 130, or it may be deformed to a configuration between the planar configuration shown in FIG. 1A and a configuration where the stamp is in contact with the surface 130.

It may be preferred for the surface 130 to have generally the same shape as a substrate on which material is to be deposited by the elastomeric stamp. For example, if material is to be transferred from the stamp to the substrate due to pressure exerted on the stamp by the substrate, the surface 130 may provide support for the stamp during material transfer. As used herein, when a thin elastomeric sheet is placed between a surface 130 and a substrate surface, and pressure of a degree normally used to transfer material from an elastomeric stamp to a substrate is applied to one or both surfaces, the region of each surface considered to be “generally the same shape” is the region in conformal contact with the elastomeric sheet. For example, referring to FIG. 1C, a substrate 160 is placed over a vacuum mold 170 having an upper surface with sections of varying curvature. When an elastomeric sheet 165 is placed between the substrate 160 and the mold 170 and pressure is applied, portions of the substrate surface and the mold surface are in conformal contact with the elastomeric sheet. In the central region 180, each surface is in conformal contact with the sheet; this region of the surfaces therefore may be described as having the same general shape or being generally the same shape. The outer regions 190 are not in conformal contact with the sheet, and therefore these regions are not generally the same shape.

The degree to which two surfaces are generally the same shape may be quantified based on the degree to which an elastomeric stamp placed between the surfaces deforms to be in conformal contact with both surfaces. As used herein, two surfaces are generally the same shape if, when an elastomeric stamp is placed between them and pressure typical of the pressure used to transfer material from an elastomeric stamp to a substrate is applied, each surface the elastomeric stamp does not deform more than about 1 μm to be in conformal contact with the adjacent surface.

The elastomeric stamp may be used to deposit material on a non-planar substrate. Any non-planar substrate may be used, with substrates having at least one surface with a three dimensional curvature being preferred. Preferably, the material to be deposited and transferred is a metal or a metallic compound, though other materials may be used. For example, the material may be an organic material, insulator, or semiconductor. Organic materials may comprise polymers and/or small molecules. As used herein, the term “organic” includes polymeric materials as well as small molecule organic materials that may be used to fabricate organic optoelectronic devices. “Small molecule” refers to any organic material that is not a polymer, and “small molecules” may actually be quite large. Small molecules may include repeat units in some circumstances. For example, using a long chain alkyl group as a substituent does not remove a molecule from the “small molecule” class. Small molecules may also be incorporated into polymers, for example as a pendent group on a polymer backbone or as a part of the backbone. Small molecules may also serve as the core moiety of a dendrimer, which consists of a series of chemical shells built on the core moiety. The core moiety of a dendrimer may be a fluorescent or phosphorescent small molecule emitter. A dendrimer may be a “small molecule,” and it is believed that all dendrimers currently used in the field of OLEDs are small molecules. In general, a small molecule has a well-defined chemical formula with a single molecular weight, whereas a polymer has a chemical formula and a molecular weight that may vary from molecule to molecule.

The material may be deposited on the stamp while the stamp is in a planar configuration or after the stamp has been deformed to a shape generally the same as the shape of the non-planar substrate. The elastomeric stamp may be deformed with a vacuum mold; when the vacuum is released or decreased the stamp may become less deformed, i.e., more planar. Pressure may be applied to transfer material from the coated stamp to the substrate. Pressure may be applied due to the elasticity of the stamp, by applying a force to the substrate and/or the stamp, or both.

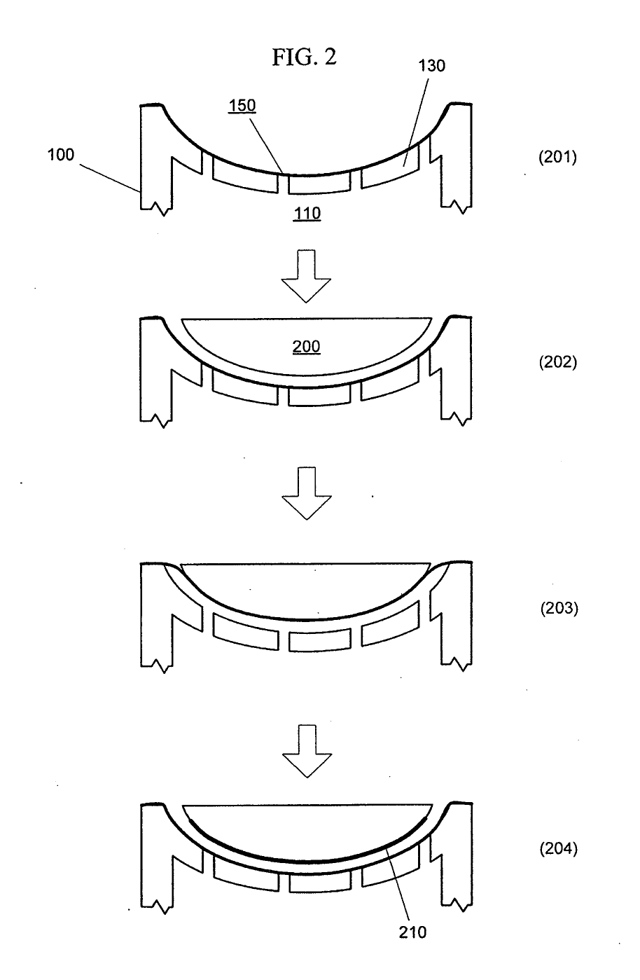

FIG. 2 shows a method of depositing material on a substrate 200 using a vacuum mold 100 and an elastomeric stamp 150. For clarity, only a portion of the vacuum mold in the region of the stamp is shown. Steps 201-204 are indicated by reference numerals shown in parentheses. As previously described, an elastomeric stamp 150 may be placed over an opening in a vacuum mold 100 and hermetically sealed to the edge of the opening. When a vacuum is applied to an internal cavity 110 of the vacuum mold, the elastomeric stamp may be deformed into the mold (201). The stamp 150 may be coated with the material to be deposited before it is deformed, i.e., while in a planar configuration, or it may be coated after being deformed into the vacuum mold.

A non-planar substrate 200 on which material to be deposited is placed in close proximity to the coated, deformed stamp (202). A substrate having one-dimensional curvature, such as the curved surface of a cylinder, may be used. Preferably, the substrate has two-dimensional curvature. Typically, the substrate has at least one surface that is non-developable. That is, the surface is a topological shape that cannot be flattened onto a plane without distortion such as stretching, compressing, or tearing. The entire substrate may be non-developable, such as where a substrate is created by deforming a thin sheet to have a dome or semi-spherical shape. Pressure may be applied between the substrate 200 and the coated stamp 150 to transfer material from the stamp surface to the substrate. For example, as shown in FIG. 2 the vacuum may be released or decreased. Due to the elastic properties of the stamp, the stamp may then relax until it is in conformal contact with the substrate (203). Other procedures may be used to exert force between the substrate and the stamp. After pressure has been applied between the substrate and the stamp, the stamp may be removed from the substrate. A layer 210 of material is deposited on the substrate surface. The material may be deposited over the entire surface of the substrate such as the curved surface shown in FIG. 2, or it may be deposited on only a portion of the substrate surface.

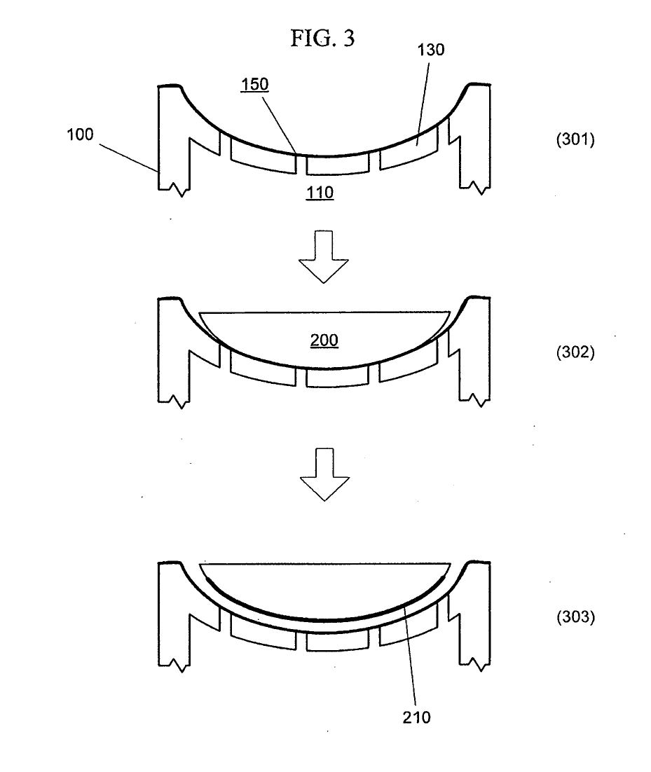

Material may also be transferred from the stamp to the substrate by directly applying pressure between the stamp and the substrate. FIG. 3 shows a method of depositing a layer of material on a non-planar substrate using an elastomeric stamp. As previously described, the stamp may be deformed and coated with the material to be deposited (301). The stamp 150 may be coated with the material to be deposited before it is deformed, i.e., while in a planar configuration, or it may be coated after being deformed into the vacuum mold. The stamp may be deformed into the vacuum mold 100 until it contacts the surface 130. Preferably, the stamp may contour the surface 130. While the stamp is deformed into the vacuum mold, a substrate 200 may be placed on the stamp (302) and pressure applied between the stamp and substrate to transfer material from the stamp to the substrate. For example, a force may be applied to the substrate. The substrate then may be removed from the stamp (303), with the deposited layer 210.

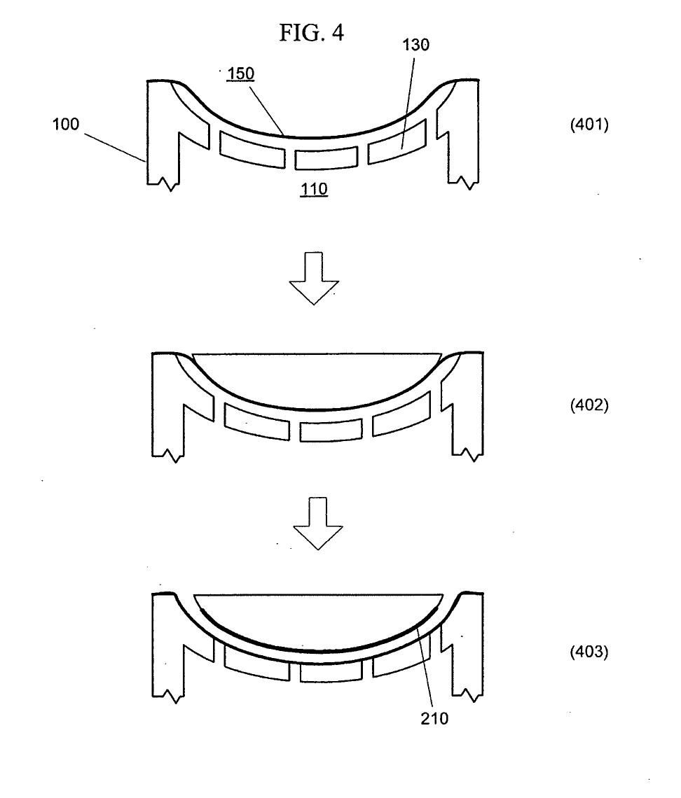

The vacuum mold may also be used to remove the stamp from the substrate after material is transferred. For example, FIG. 4 shows a process similar to that shown in FIG. 3. In FIG. 4, an elastomeric stamp 150 is fixed in a deformed configuration (401). For example, a planar PDMS stamp may be placed over a vacuum mold, and a vacuum applied to deform the stamp to a desired configuration. The stamp may be further deformed after being fixed in a deformed configuration, but once the additional deforming force is removed, the stamp will return to the fixed configuration. The stamp may be fixed into a new configuration by further deforming and heating the stamp. Other materials and processes may be used to form a stamp of a desired configuration, such as elastomeric materials that may be fixed by curing with radiation, such as ultraviolet light, heat, chemical reaction, or other processes. The stamp may be coated with a material to be deposited after it has been fixed in a deformed configuration, or it may be coated while in a planar configuration, before it has been fixed in a deformed configuration. A substrate 200 may be placed against the coated, pre-deformed stamp and pressure applied between the stamp and the substrate to transfer material from the stamp to the substrate (402). The coated substrate may then be removed from the stamp (403).

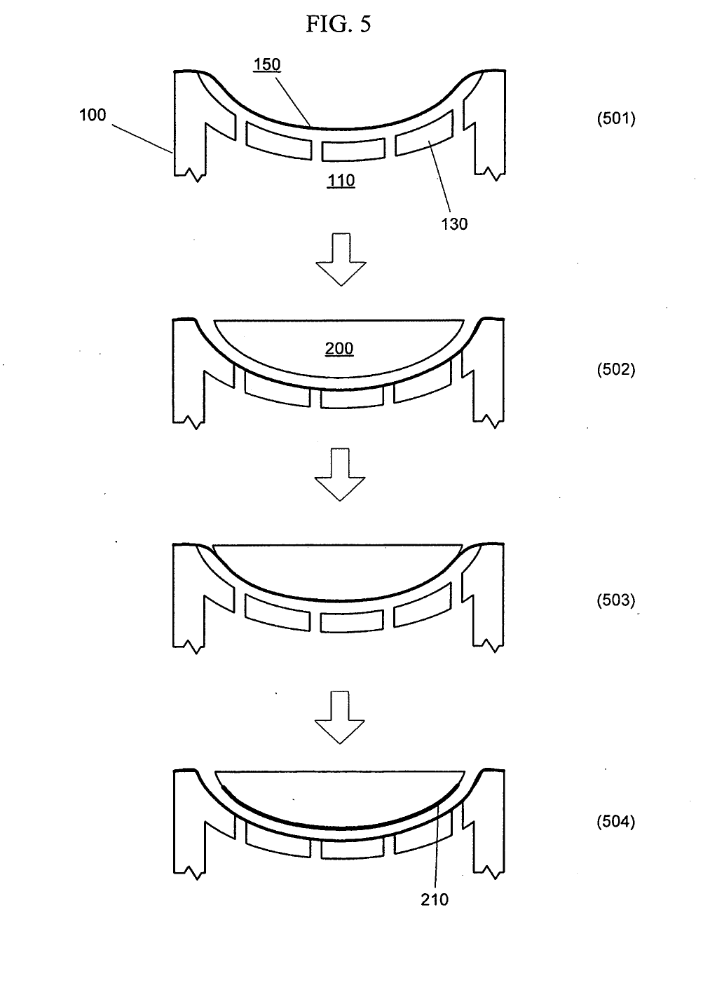

As previously described with respect to FIG. 2, the elasticity of an elastomeric stamp can also be utilized to exert pressure between the stamp and a non-planar substrate. Referring to FIG. 5, a pre-deformed, coated stamp may be attached to a vacuum mold as previously described with respect to FIG. 4 (501). The pre-deformed stamp may be further deformed into the vacuum mold by application of a vacuum to the vacuum mold and a substrate may be placed over the stamp (502). When the vacuum is reduced or removed, the elasticity of the stamp may cause it to return to the fixed, deformed configuration and come into conformal contact with the non-planar substrate (503). The elasticity of the stamp may further cause the stamp to exert pressure against the substrate, transferring material from the stamp to the substrate. After material has been transferred, a vacuum may be applied to the mold to further deform the stamp and remove the stamp from the substrate (504).

The various method steps shown in FIGS. 2-5 may be performed in an order different than that indicated by the reference numerals. For example, the elastomeric stamp may be coated with the material to be deposited before being placed on and/or hermetically sealed to the vacuum mold. It also may be coated before being deformed and/or fixed in a deformed configuration. Other variations from the illustrated order may be used without affecting the results described herein.

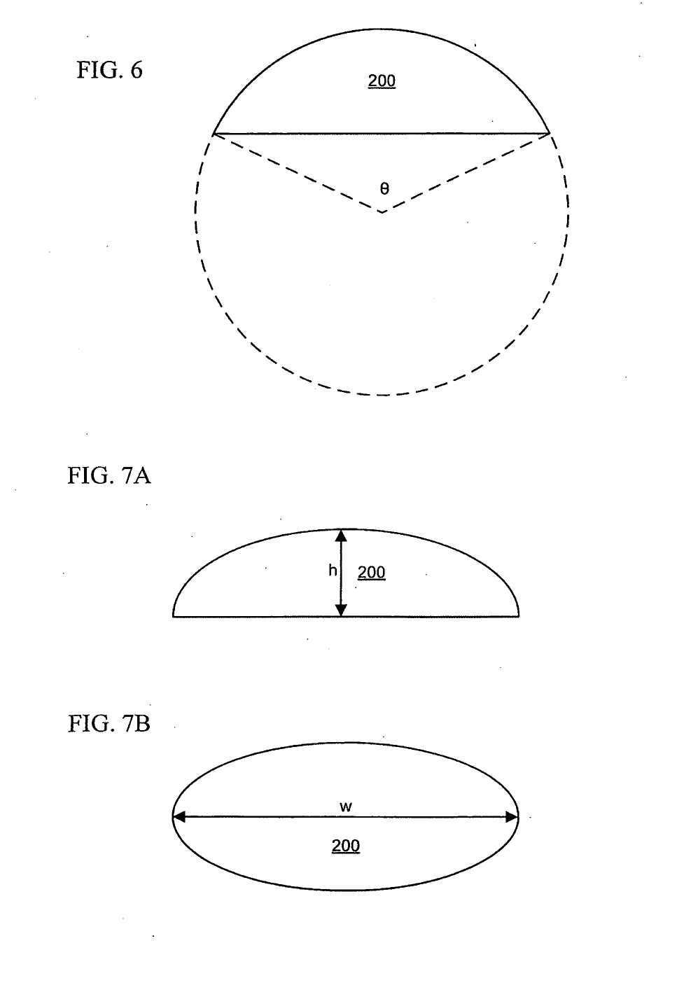

Various substrate shapes may be used. Substrates having a surface that is ellipsoidal or semi-spherical may be preferred. An ellipsoidal surface is one formed by rotation of an elliptical curve around an axis. A semi-spherical surface is one having a cross-section that is an arc. A semi-spherical substrate may be characterized by the angle subtended by a cross-section of the substrate. For example, FIG. 6 shows a substrate which subtends an angle of E. It may be preferred for a circular substrate to subtend an angle of 60-120°. Other shapes may be used. Typically, non-planar substrates will have at least one continuously curved surface. A non-planar substrate may be further characterized by the major axis measured across a flat surface of the substrate, and the maximum height of the substrate measured along a line perpendicular to a flat surface of the substrate to a point on the curved surface of the substrate. FIG. 7A shows a cross-section of a non-planar substrate having a flat surface and a curved surface, with a maximum height of h. FIG. 7B shows a bottom view of the same substrate as in FIG. 7A, with the major axis w identified. For an ellipsoidal substrate having a planar base, the major axis is the same as the major axis of the ellipse formed by the base of the substrate. If a non-planar substrate does not have a planar surface, the major axis may be identified relative to the shape defined by the substrate when viewed from above or below. For example, a thin, dome-shaped or semi-spherical substrate having a convex outer surface and a concave inner surface defines an ellipse or a circle when viewed from below. For other shapes of substrates, the major axis may be identified as the longest distance measured across a flat surface of the substrate or across the shape defined by the substrate when viewed from below. In general it is preferred for the ratio of the maximum height of the non-planar substrate to the major axis of the non-planar substrate to be at least 0.1.

Various processes may be used to effectuate transfer of material from the elastomeric stamp to the substrate while the stamp and the substrate are in contact, such as in configurations (203), (302), (402), or (503). A preferred method of transferring material is the use of cold welding. As used herein, cold welding refers to bonding of like materials at room temperature due to an application of pressure, such as bonding between two metals. Additional information regarding cold welding is provided in U.S. application Ser. No. 10/387,925 filed Mar. 13, 2003 to Kim et al., the disclosure of which is incorporated by reference in its entirety. Properties of the material being deposited may also be used. For example, the substrate and the stamp may be brought into contact for a time sufficient to allow a self-assembled monolayer of the material to form on the substrate. A chemical reaction may also occur or be induced to assist with material transfer or strengthen the bond between the substrate and the deposited material. Additional curing or bonding agents may be used to improve or affect the transfer of material. For example, heat, ultraviolet light, or an oxidizing agent may be applied to the stamp, the substrate, or both. Such agents may be applied in the configurations previously referenced, or they may be applied before the stamp and the substrate are in contact. It may be preferred to treat the stamp, the substrate, or both with a plasma oxidation process prior to placing the substrate on the stamp; such treatment has been found to improve adhesion of the deposited material to the substrate.

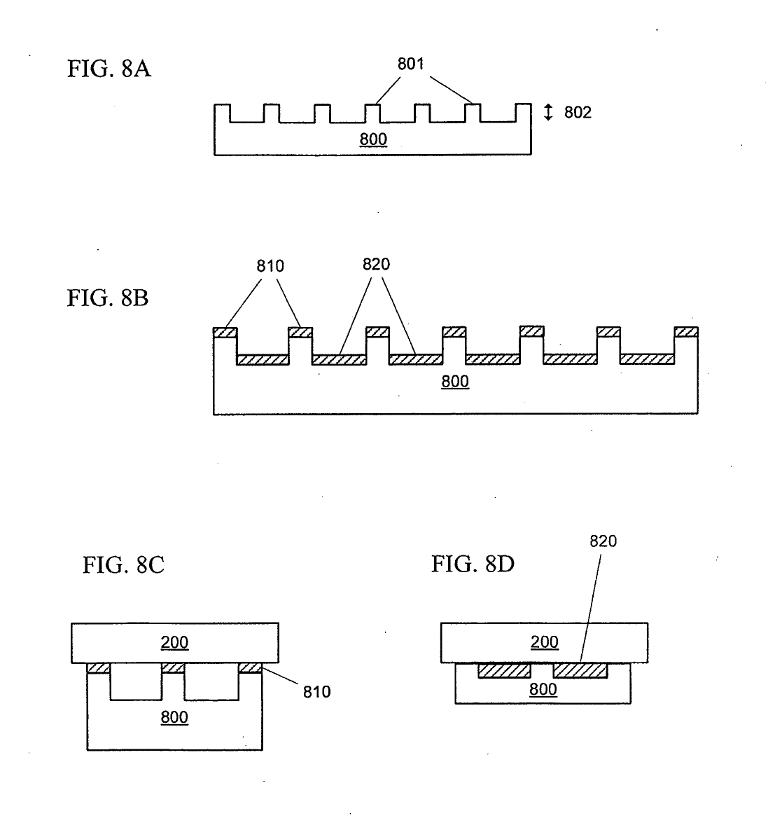

It may be preferred for the stamp to be patterned, such as when an electrode is to be deposited. The pattern preferably has raised features extending to a depth greater than the thickness of the electrode or material to be deposited. FIG. 8A shows an exemplary patterned elastomeric stamp 800 with raised features 801 extending a distance 802 from the base of the stamp. The raised features 801 may all have the same dimensions, or various patterns may be used. As a specific example, when the stamp is used to deposit an electrode for use in an optoelectronic device, the raised features may be arranged in a pattern useful for such an electrode, such as a grid, parallel strips, or other pattern. FIG. 8B shows a patterned elastomeric stamp coated with a material to be deposited on a substrate. The stamp may be coated on the outer surface of the pattern features 810, in the spaces between the pattern features 820, or both, using deposition techniques known in the art. After the pattern is coated, material may be transferred to a substrate 200 by applying pressure between the stamp and the substrate as previously described. FIG. 8C shows a patterned stamp transferring material to a substrate. When the regions between the pattern features are coated, material may be transferred by applying pressure sufficient to compact the stamp and cause these regions to come into contact with the substrate, as illustrated in FIG. 8D. Although FIGS. 8C and 8D illustrate a planar substrate for clarity, it will be understood that a non-planar substrate as previously described may be used.

The elastomeric stamp may be made of any suitable material, with PDMS being preferred. The stamp may be a hybrid stamp, i.e., have multiple layers of different elastomeric materials of varying elasticity or hardness. For example, a stamp may have a hard, less elastic center portion and a soft, more elastic outer portion. The stamp may have a gradient elasticity and/or hardness. Such hybrid stamps may be useful for depositing on substrates having high curvature, since it may be desirable for the inner portions of the stamp to deform more or less easily than the outer portions. The specific configuration of a hybrid stamp may be matched to the degree of deformation each region of the stamp is expected to undergo when depositing material on a specific substrate.

The substrate can be any suitable material, with PETg being preferred. A substrate may contain multiple layers, such as a non-planar PETg dome coated with a uniform layer of metal. The substrate may include additional pre-deposited layers, such as strike layers. It may also be treated, such as with a chemical precursor or radiation, to enhance bonding between the substrate and the material deposited by the stamp. A vacuum mold such as described with respect to FIG. 1A can be used to create a non-planar substrate. Such a process may be desirable to construct a substrate and a deformed elastomeric stamp having the same shape. For example, a PETg substrate may be placed into a vacuum mold having a concave surface, such as surface 130 in FIG. 1, and heated until the substrate contours the surface. The substrate may then be removed and an elastomeric stamp placed in the mold and deformed as previously described. The substrate may then be placed over a coated, deformed stamp to transfer material from the coated stamp to the substrate.

Deposition of material onto a non-planar or three dimensional substrate is believed to be useful for a variety of applications, including organic light emitting, photosensitive devices, and other optical applications. The methods described herein, for example, may be used to deposit a metal electrode onto a non-planar substrate for use in an optoelectronic device. Such devices may include a plurality of organic layers disposed, for example, between metal electrodes. Where a first layer is described as “disposed over” a second layer, the first layer is disposed further away from substrate. There may be other layers between the first and second layer, unless it is specified that the first layer is “in physical contact with” the second layer. For example, a cathode may be described as “disposed over” an anode, even though there are various organic layers in between.

In one embodiment, organic photodetectors are fabricated by the methods described in FIGS. 1-8. Preferably, the detectors include a double heterojunction structure, as described in U.S. Pat. No. 7,196,366, which is incorporated by reference in its entirety. More preferably, the organic donor material of each organic photoactive region of the double heterojunction photodetector is CuPc and the organic acceptor material of each organic photoactive region is C₆₀. The photodetector may also include a bathocuproine (BCP) exciton blocking layer.

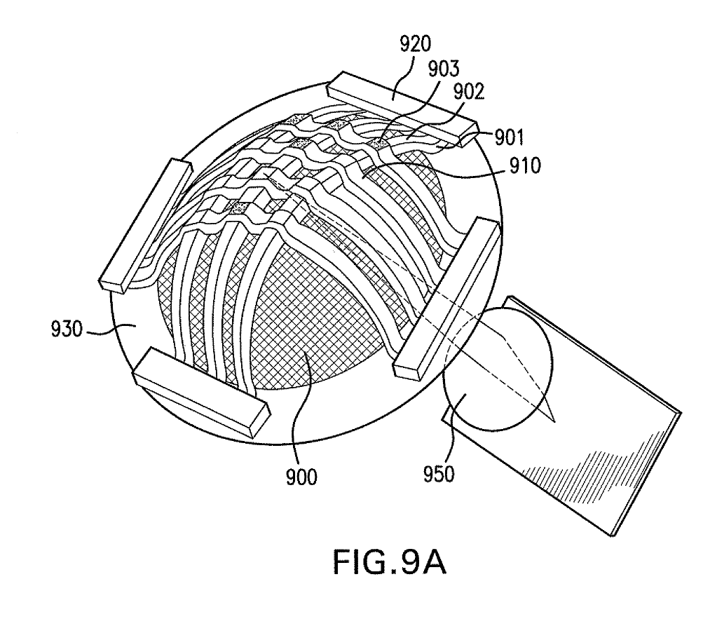

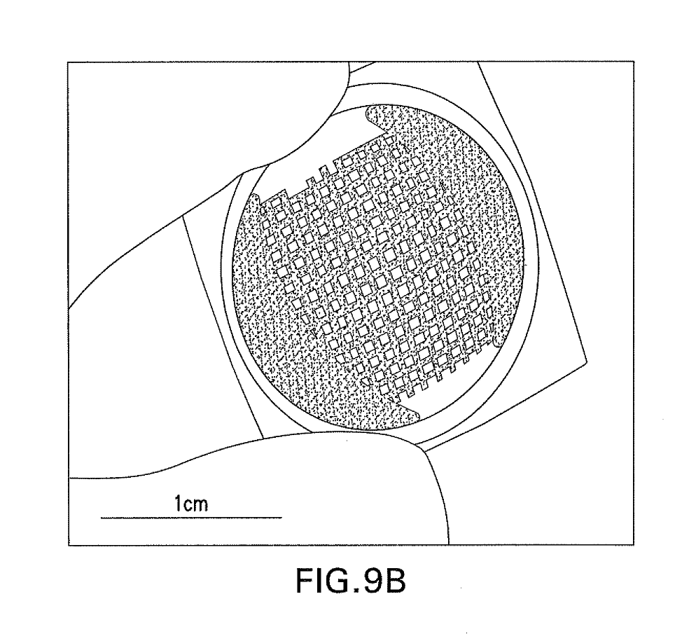

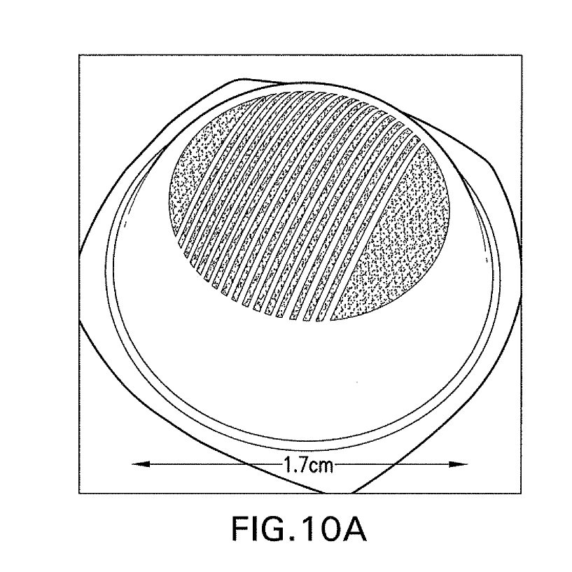

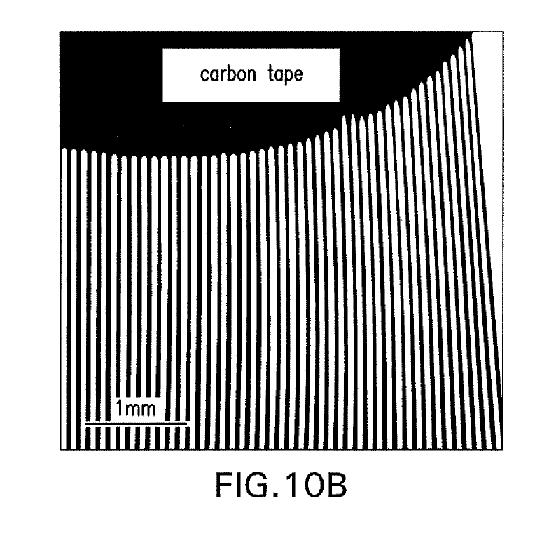

Organic photodetector focal plane arrays (FPAs) that mimic the size, function, and architecture of the human eye may be fabricated by the method described in FIGS. 1-8. The imaging system of the human eye, which is approximately spherical, has the advantages of having a wide field of view that is generally free of image distortion and a low f-number due to its single lens element. An imaging system is provided by fabricating a focal plane array onto a nearly spherical surface that approximates or matches the curvature of a single lens element. FIG. 9A shows an organic, passive matrix FPA 900 on a hemispherical substrate 930. The FPA includes two perpendicular electrode stripe arrays, anode 901 and cathode 903, placed above and below continuous layers of organic semiconductor materials 902 forming the active photodetection regions 910. Individual photodetectors are defined at crossings of the electrode stripes, where device read-out is realized by probing the appropriate row and column electrodes. FIG. 9A also illustrates focusing lens 950 producing an image of an object on the spherical focal plane. The illustration of the readout circuit 920 is intended to be conceptual. FIG. 9B illustrates the FPA with micrometer scale dimensions (11×13 array of (500 μm)² photodetectors) on curved surfaces with radius of about 1 cm or less. An exemplary embodiment of a method of fabricating an FPA on a three dimensional surface is described below and illustrated in FIGS. 10A-10B.

### EXPERIMENTAL

A flat transparent glycol-modified polyethylene terephthalate (PETg) sheet is drawn by vacuum into a shaped Al mold, while being heated to about 140° C. above its softening temperature. The mold is then cooled to freeze or maintain the substrate shape. A 2 nm Cr adhesion layer and a 6 nm Au strike layer are thermally deposited onto the outer surface of the hemisphere in vacuum.

A PDMS stamp was replicated from a patterned Si master. A flat PDMS stamp with an array of raised ridges that corresponds to the positions of the metal columns on the FPA is fabricated using a pre-etched Si master consisting of an array of parallel, 40 μm or 500 μm wide by 15 μm high ridges, each separated by a distance equal to their widths. The masters were patterned using conventional photolithography techniques. A curing agent and PDMS prepolymer were mixed at about a 1:7 weight ratio. After degassing for about one hour, the prepolymer mixture was coated onto the Si master and cured at 100° C. for one hour.

The stamp is coated with a 10 nm Au layer by vacuum thermal evaporation and is deformed into a hemispherical shape by applying vacuum to its flat surface using the shaped Al mold. The spherical substrate is placed onto the mold in close proximity to the deformed PDMS stamp. The vacuum is released causing the elastomeric PDMS stamp to relax and make conformal contact with the PETg substrate. A bond is formed between the metal-coated ridges on the stamp and the strike layer. The vacuum was then reapplied to remove the PETg from the PDMS stamp, leaving behind the metal pattern (stripes) on the hemisphere. The strike layer was then removed by sputtering in a 30 sccm, 20 Torr, and 100 W Ar plasma etching for about 2 minutes.

Organic semiconductor layers forming the diode active region are evaporated across the surface of the hemisphere. The double heterojunction photodetectors consisted of a 50 nm CuPc donor layer, a 50 nm C₆₀ acceptor layer, a 10 nm bathocuproine (BCP) exciton blocking layer, and a 6 nm Ag strike layer, grown sequentially by vacuum thermal deposition. An array of 20 nm Ag cathode columns are applied by a similar stamping process described in the preceding paragraph. The cathode arrays are oriented perpendicular to the Au metal rows. The strike layer was then removed by Ar plasma etching.

Using this method, an Au or Ag electrode of thickness up to 20 nm were transferred onto a 1 cm radius hemispherical substrate, as shown in FIGS. 10A and 10B. FIG. 10A shows an optical microscope image of a 500 μm wide, 1 cm long, 10 nm thick Au stripe array transferred onto a PETg hemisphere. FIG. 10B shows a scanning electron microscope image of an array of 40 μm wide stripe patterned on a hemispherical substrate. The distortions along the edge of the interconnect array is believed to be due to 3D deformation of the parallel stripes on the planar stamp, and may be corrected by modifications to the stamp pattern to resolutions of <10 μm.

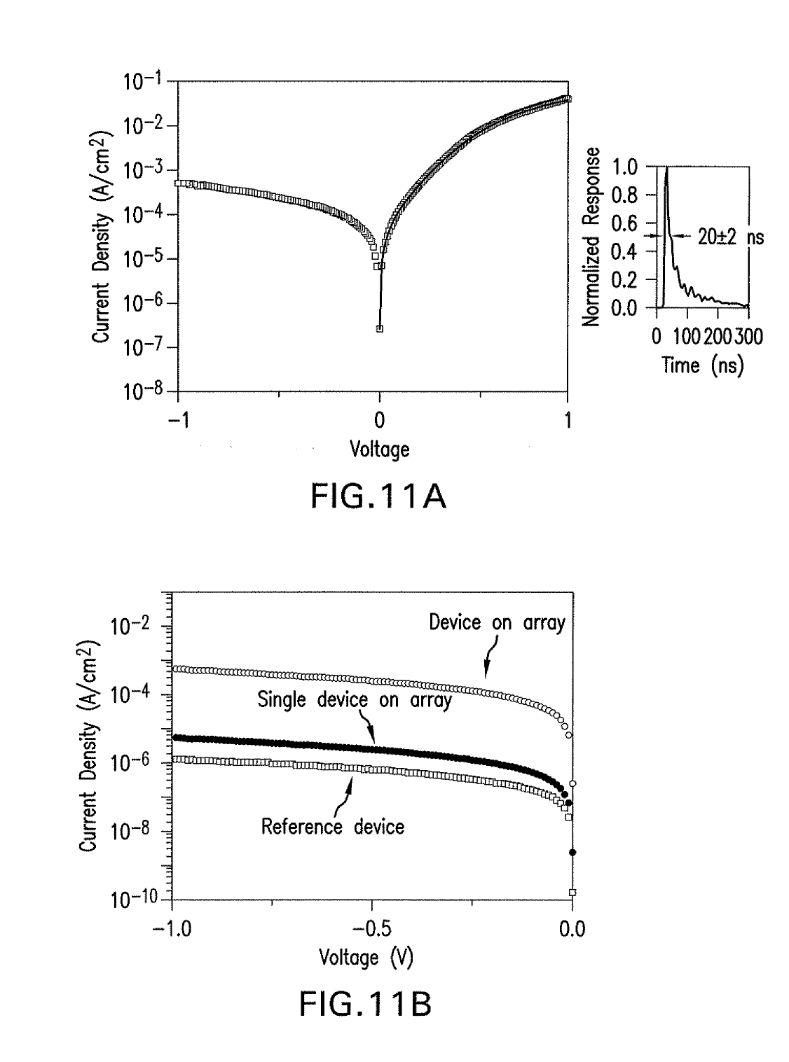

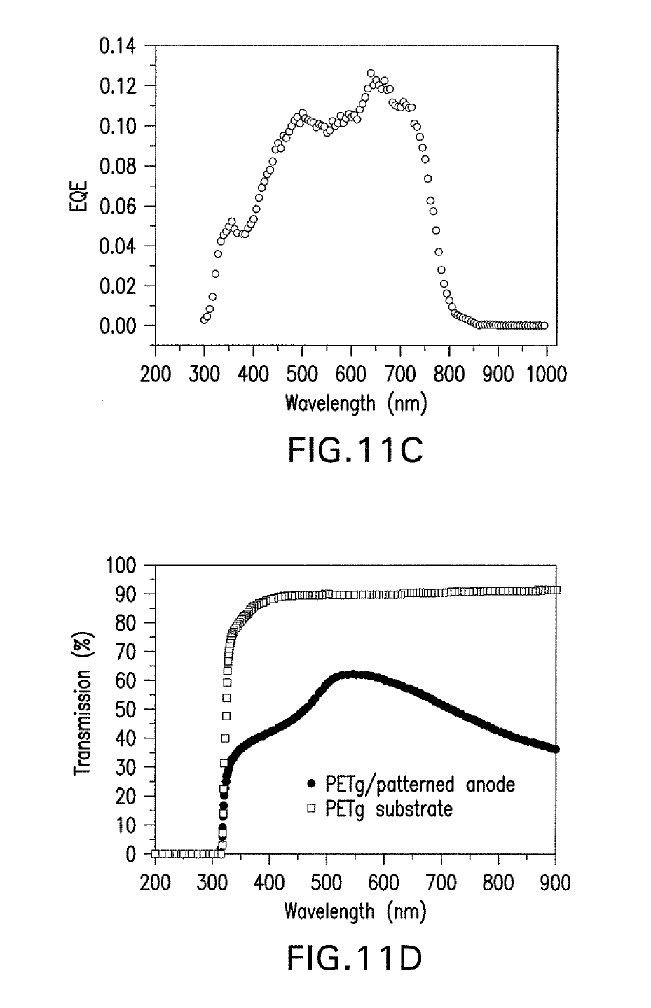

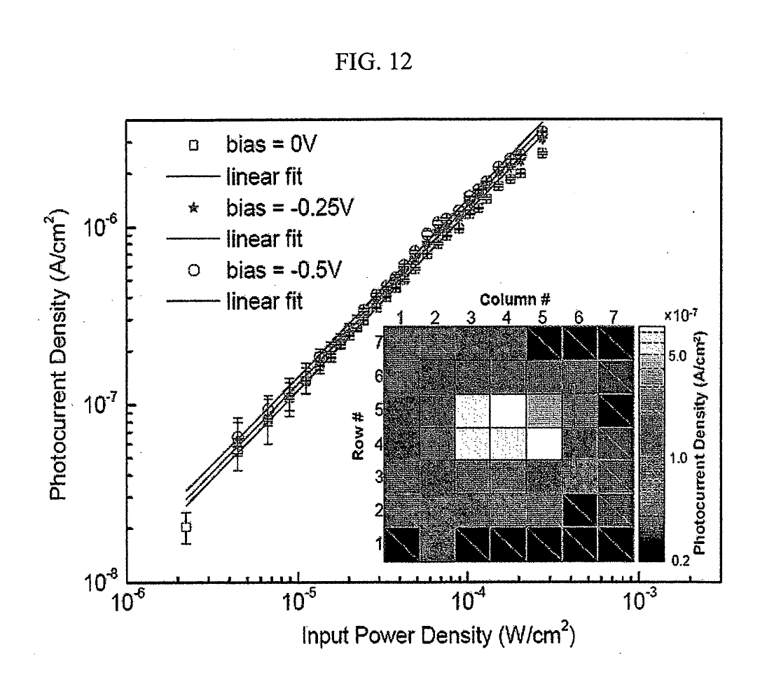

Electrical characterization of individual pixels was performed on the 100×100 array of (40 μm)² organic photodetectors fabricated on a 1 cm radius hemispherical substrate. FIG. 11A shows the current density vs. voltage characteristics under forward and reverse bias. The data at <0.5 V forward bias was fit (solid line) using the modified Shockley equation, J=Jₛ·exp(qV−JRₛₐ)/n′kT, where the specific series resistance Rₛₐ=0.33±0.01 Ω·cm², saturation current density Js=60±2 μAcm⁻² and n′=3.49±0.03. FIG. 11A shows photodetector dark currents measured along a row or column yielded a total current density of 530±20 μAcm⁻² at −1V, which is about 100 times greater than for an individual diode. The dark current density for an isolated device is estimated at less than or equal to 5.3±20 μAcm⁻².

FIG. 11A (inset) shows the photodetector temporal response of to an optical pulse as about 20±2 ns characterized by illumination with a 5 Hz train of 700 ps full width at have maximum (FWHM) pulses at λ=475 nm from a dye pumped with a N₂ laser. The average optical power was about 0.29±0.02 μJ over a 5 mm diameter illuminated spot. The response is limited by the detector resistance and capacitance, where a series resistance of approximately 20 kΩ is estimated from the forward-biased current density vs. voltage characteristic shown in the solid line of FIG. 3A, and the capacitance measured at 10 kHz was 1.31±0.01 pF. The response time is believed to be compatible with pixel readout rates of about 10⁷ pixels/sec, which is has a frame readout rate of over 30 frames/sec video standard for a 640×480 pixel array. It is therefore believed that real-time imaging applications may be achieved with the exemplary architecture.

FIG. 11B shows this is comparable to that measured for an analogous 1 mm-diameter reference device on a flat glass/ITO substrate. FIG. 11B shows the total dark current density under reverse bias (open circles) and estimated dark current of a 40 μm detector (closed circles) in a 100×100 focal plane array. The reversed biased dark current density of a device on a flat substrate (open squares) is shown for comparison.

FIG. 11C shows the external quantum efficiency as greater than 10% for wavelengths between λ=480 nm to 740 nm, peaking at 12.6±0.3% at λ=640 nm. FIG. 11D shows a transmission spectrum of the PETg substrate with and without a 100 Å patterned Au anode array. FIG. 11D shows transmission through the 10 nm Au layer on PETg as about 60% at λ=640 nm. This is believed to be lower than the external quantum efficiency and internal quantum efficiency of previously reported CuPc/C₆₀/BCP double heterojunction photodetectors.

FIG. 12 illustrates the imaging capabilities of hemispherical FPAs for a 20×20 array of (200 μm)² pixels spaced by 300 μm on a 1 cm radius hemisphere. The detector dynamic range was extracted by measuring the photocurrent of a single device under different illumination levels at λ=633 nm and three different bias voltages. Data fits at each bias (solid lines) show approximately linear photocurrent variation with optical power in the range of about 2 to about 200 μWcm⁻². The dynamic range (DR) is defined as 10 log(P₁/P₀), where P₁ is the optical power for 1 dB photocurrent compression at high intensities and P₀ is the lowest detectable optical power. For 0V bias, DR=20 dB, corresponding to a 7-bit grayscale. At higher reverse bias, 1 dB compression point exceeds the highest input power while P₀ remains the same. The increased linearity is believed to increase the DR due to the space charge field that sweeps out more free carriers at high intensity.

FIG. 12 (inset) shows imaging capabilities when a rectangular 1.3×0.8 mm² aperture is placed in proximity to the hemispherical center line and illuminated at λ=633 nm at 00 μWcm⁻². The illuminated area included a 2×3 pixel block and portions of the immediately adjacent pixels. Photocurrents from pixels within a 7×7 block including the illuminated area were measured and used to generate the 7-bit grayscale image in FIG. 12 (inset). The rectangles under the dashed lines show the approximate extent of the illuminated area. A contrast of about 99% exists between the highest and lowest pixel photocurrents located, respectively, at the center and periphery of the block. A photocurrent non-uniformity of 13% is observed among pixels in the high-illumination 2×3 pixel block, excluding the pixel at position (5,5). Gray levels at partially illuminated pixels on the periphery of the rectangle exhibit a minimum contrast of about 71% with respect to the maximum photocurrent. The observed non-uniformities are believed to be caused by imperfections to the imaging system, light leakage, light scattering from metal contact surfaces, and slight variations in the individual pixel characteristics.

While the present invention is described with respect to particular examples and preferred embodiments, it is understood that the present invention is not limited to these examples and embodiments. The present invention as claimed therefore includes variations from the particular examples and preferred embodiments described herein, as will be apparent to one of skill in the art.

What is claimed is:

1. A method of fabricating an optoelectronic device comprising:
coating the surface of an elastomeric stamp with a material to be deposited;
deforming the elastomeric stamp; and transferring the material from the elastomeric stamp to the non-planar substrate.

2. The method of claim 1, wherein the elastomeric stamp is deformed by applying a vacuum to a vacuum mold to which the elastomeric stamp is hermetically sealed.

3. The method of claim 1, wherein the non-planar substrate is placed in close proximity to the deformed elastomeric stamp and the material is transferred by applying a force between the coated, deformed elastomeric stamp and the non-planar substrate.

4. The method of claim 1, wherein at least one surface of the non-planar substrate has three-dimensional curvature.

5. The method of claim 1, wherein the material to be deposited is a metal.

6. The method of claim 5, wherein the non-planar substrate is coated with a metal strike layer prior to the transfer; and wherein the transfer of the metal from the elastomeric stamp to the non-planar substrate causes the metal to cold weld to the substrate.

7. The method of claim 6, further comprising removing the metal strike layer by etching.

8. The method of claim 1, wherein the elastomeric stamp is patterned with raised features extending to a depth greater than the thickness of the material to be deposited.

9. The method of claim 1, wherein the non-planar substrate is semi-spherical and subtends an angle of 600-120°.

10. The method of claim 1, wherein the elastomeric stamp comprises PDMS per polymer.

11. The method of claim 1, wherein the material to be deposited is an organic material, insulator, or semiconductor.

12. A method of fabricating an optoelectronic device comprising:
deforming an elastomeric stamp;
coating the surface of the deformed elastomeric stamp with a material to be deposited; and
transferring the material from the elastomeric stamp to the non-planar substrate.

13. A method of fabricating an optoelectronic device comprising:
coating the surface of an elastomeric stamp with a first metal;
deforming the elastomeric stamp;
coating a non-planar substrate with a first metal strike layer;
transferring the first metal from the elastomeric stamp to the non-planar substrate by cold welding, wherein the first metal forms a first electrode; and
depositing a plurality of organic layers over the non-planar substrate.

14. The method of claim 13, further comprising:
coating a second elastomeric stamp with a second metal;
deforming the second elastomeric stamp; and
transferring the second metal from the elastomeric stamp onto the organic layers such that the second metal is disposed over the organic layers, wherein the second metal layer forms a second electrode.

15. The method of claim 14, wherein a second metal strike layer is coated onto the organic layers prior to the transfer; and wherein the transfer of the second metal from the elastomeric stamp causes the second metal to cold weld to the second metal strike layer.

16. The method of claim 14, wherein the first and second electrodes are arranged perpendicular to each other.

17. The method of claim 14, wherein the device is a focal plane array.

18. The method of claim 17, wherein the device is an organic photodetector.

19. The method of claim 14, wherein the device comprises a double heterojunction structure.
